(19) United States
(12) Patent Application Publication
(10) Pub. No.: US 2026/0038796 A1
(43) Pub. Date: Feb. 5, 2026

(54) FACILITY FOR MANUFACTURING ELECTRODES

(71) Applicant: SK ON CO., LTD., Seoul (KR)

(72) Inventors: Min Chan KWON, Daejeon (KR); Kwon Hyung LEE, Daejeon (KR)

(21) Appl. No.: 19/274,646

(22) Filed: Jul. 21, 2025

(30) Foreign Application Priority Data
Jul. 31, 2024 (KR) 10-2024-0101535

(51) Int. Cl. H01M 4/04; B05C 5/02

(52) U.S. Cl. CPC H01M 4/0411; B05C 5/0254

(57) ABSTRACT

Disclosed is a facility for manufacturing electrodes. According to an embodiment of the present disclosure, the facility for manufacturing electrodes may a heating roll which includes a heating roll shaft extending in a longitudinal direction and a heating roll contact surface rotatably coupled to the heating roll shaft about the heating roll shaft; a slot die disposed to face the heating roll while being spaced apart therefrom, and configured to dispense a slurry; a roll heating unit configured to heat the heating roll contact surface; and an electrode drying unit which includes a drying housing and a heater positioned inside the drying housing.

### CROSS-REFERENCE TO RELATED APPLICATION

This patent application claims the priority and benefits of Korean patent application No. 10-2024-0101535, filed on Jul. 31, 2024 the disclosure of which is incorporated herein by reference in its entirety.

### BACKGROUND

### 1. Field of the Invention

The present disclosure relates to a facility for manufacturing electrodes.

### 2. Description of the Related Art

Electrodes used in a secondary battery may include an electrode foil and a coating layer applied to the electrode foil. The coating layer may be formed by applying a slurry to the electrode foil. During the drying process after the slurry is applied to the electrode foil, a migration may occur, in which components of the electrode migrate undesirably or become misaligned. Such the migration phenomenon may weaken the bonding force between the coating layer and the electrode foil.

### SUMMARY

An embodiment of the present disclosure is to provide a facility for manufacturing electrodes that is capable of drying an electrode sheet through two separate drying processes.

A facility for manufacturing electrodes according to the present disclosure may include: a heating roll which includes a heating roll shaft extending in a longitudinal direction and a heating roll contact surface rotatably coupled to the heating roll shaft about the heating roll shaft; a slot die disposed to face the heating roll while being spaced apart therefrom, and configured to dispense a slurry; a roll heating unit configured to heat the heating roll contact surface; and an electrode drying unit which includes a drying housing and a heater positioned inside the drying housing.

The roll heating unit may include a conduction heating module housed in the heating roll contact surface and configured to supply heat to the heating roll contact surface.

The conduction heating module may be configured to generate heat through ohmic heating when a current is applied, and to heat the heating roll contact surface through thermal conduction.

The roll heating unit may include a radiation heating module disposed to face the heating roll contact surface and configured to emit infrared rays.

The roll heating unit may include an induction heating module including a coil having a wound shape.

The induction heating module may be configured to generate and supply a time-varying magnetic flux to the heating roll when an alternating current is applied.

The heating roll may be heated upon application of the time-varying magnetic flux.

The electrode sheet including the electrode foil may be in contact with the heating roll and may rotate in conjunction with the rotation of the heating roll.

The slot die may be disposed to face the electrode foil and be configured to apply the slurry to the electrode foil.

The slurry may be applied to the electrode foil to form a coating layer, and the coating layer may include at least one of an active material, a conductive agent and a binder.

A temperature of a portion of the electrode foil which is in contact with the heating roll may be lower than the temperature of the heating roll contact surface and higher than the temperature of the slurry.

The facility for manufacturing electrodes may include: a first heating roll which is disposed to face the slot die and serves as the heating roll; and a second heating roll which is spaced from the first heating roll and serves as the heating roll, wherein a target region, which is a portion of the electrode sheet, may be transported after coming into contact with the first heating roll, and then may come into contact with the second heating roll.

A temperature of the heating roll contact surface of the second heating roll may be higher than the temperature of the heating roll contact surface of the first heating roll.

The second heating roll may be in contact with the electrode foil.

The facility for manufacturing electrodes may further include a first transport roll and a second transport roll, which are positioned inside the drying housing and in contact with the electrode sheet, wherein the target region, which is a portion of the electrode sheet, may be transported after coming into contact with the heating roll, and may sequentially come into contact with the first transport roll and the second transport roll.

The heater may be configured to heat a region of the electrode sheet positioned between the first transport roll and the second transport roll.

The facility for manufacturing electrodes may further include a temperature sensor configured to measure a temperature of a target region of the electrode sheet positioned between the heating roll and the first transport roll.

The temperature sensor may further include: a first temperature sensor disposed to face the coating layer and configured to measure the temperature of the coating layer; and a second temperature sensor disposed to face the electrode foil and configured to measure the temperature of the electrode foil.

The facility for manufacturing electrodes may further include a vision sensor disposed to face the coating layer of the target region and configured to capture an image of the coating layer.

The facility for manufacturing electrodes may further include a controller configured to receive signals from the temperature sensor and the vision sensor, wherein the controller may control at least one of the heating roll and the heater based on at least one of the temperature and the image of the target region.

According to an embodiment of the present disclosure, a facility for manufacturing electrodes capable of drying an electrode sheet through two separate drying processes may be provided.

The facility for manufacturing electrodes of the present disclosure may be used for manufacturing eco-friendly electric vehicles, hybrid vehicles, and the like, which are aimed at mitigating climate change by reducing air pollution and greenhouse gas emission.

### BRIEF DESCRIPTION OF THE DRAWINGS

The above and other embodiment, features and other advantages of the present disclosure will be more clearly understood from the following detailed description taken in conjunction with the accompanying drawings, in which:

FIG. 1 is a conceptual diagram illustrating a facility for manufacturing electrodes according to an embodiment of the present disclosure;

FIG. 2 is a cross-sectional view illustrating the electrode sheet shown in FIG. 1, taken on line A1-A2;

FIG. 3 is a cross-sectional view illustrating the electrode sheet shown in FIG. 1, taken on line B1-B2;

FIG. 4 is a perspective view of the heating roll shown in FIG. 1;

FIG. 5 is a plan view of the heating roll shown in FIG. 4;

FIG. 6 is a cross-sectional view illustrating the heating roll shown in FIG. 5, taken on line C-C;

FIG. 7 is a view illustrating a state in which a conduction heating module is coupled to the heating roll shown in FIG. 6;

FIG. 8 is a view illustrating a state in which a radiation heating module is positioned adjacent to the heating roll shown in FIG. 6;

FIG. 9 is a view illustrating a state in which an induction heating module is positioned adjacent to the heating roll shown in FIG. 4; and

FIG. 10 is a block diagram illustrating the facility for manufacturing electrodes.

### DETAILED DESCRIPTION OF THE INVENTION

Hereinafter, embodiments of the present disclosure will be described in detail with reference to FIGS. 1 to 10. However, these are merely illustrative and the present disclosure is not limited to the specific embodiments described by way of example.

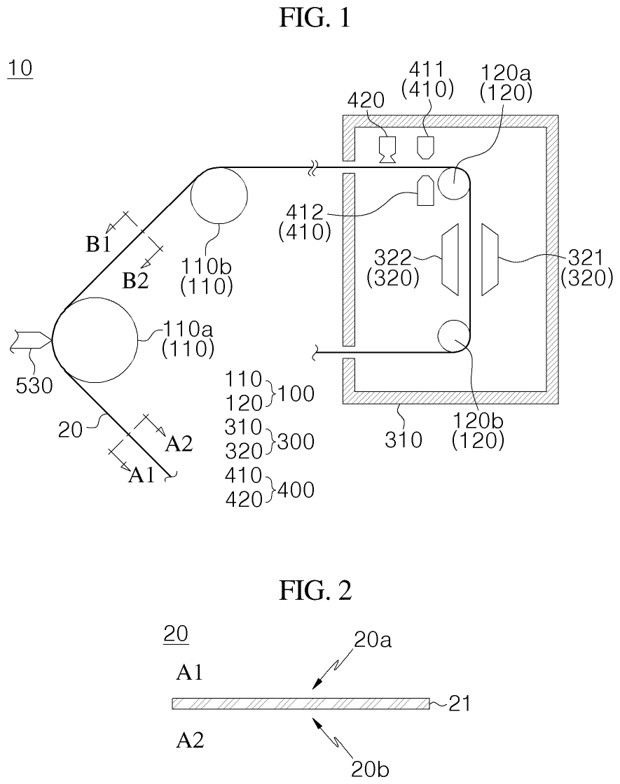

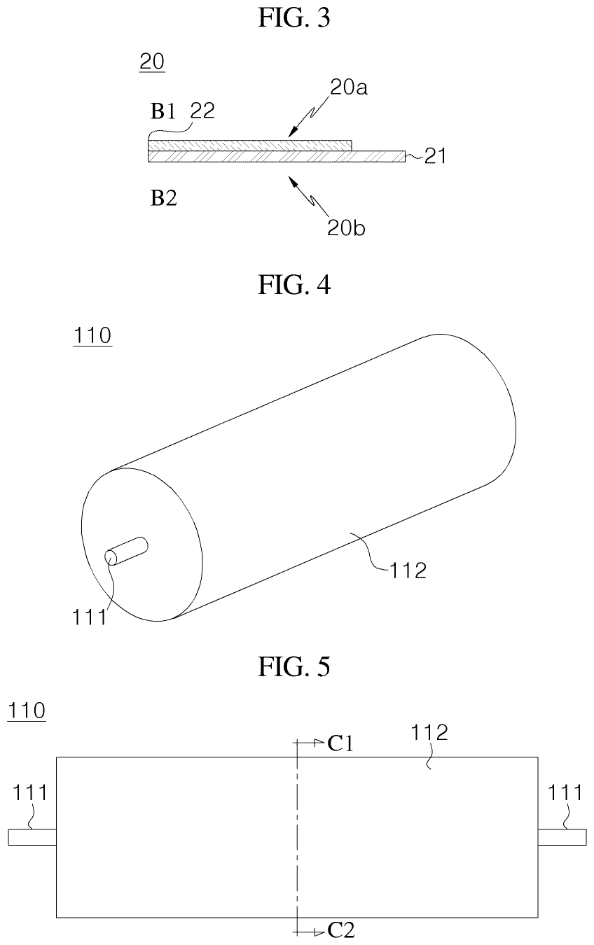

FIG. 1 is a conceptual diagram illustrating a facility for manufacturing electrodes according to an embodiment of the present disclosure. FIG. 2 is a cross-sectional view illustrating the electrode sheet shown in FIG. 1, taken on line A1-A2. FIG. 3 is a cross-sectional view illustrating the electrode sheet shown in FIG. 1, taken on line B1-B2.

Referring to FIGS. 1 to 3, an electrode sheet 20 may have two surfaces formed on opposite sides thereof. For example, a first electrode surface 20a may correspond to one surface of the electrode sheet 20. For example, a second electrode surface 20b may correspond to the other surface of the electrode sheet 20.

The electrode sheet 20 may include an electrode foil 21. The electrode foil 21 may be formed of a metal material. For example, the electrode foil 21 may be a metal thin-film.

The electrode sheet 20 may include a coating layer 22. The coating layer 22 may include at least one of a conductive agent, an active material and a binder. The coating layer 22 may be applied to one surface of the electrode foil 21.

For example, the coating layer 22 may be formed by applying a slurry to the first electrode surface 20a of the electrode foil 21. The electrode foil 21 and the coating layer 22 may form a laminated structure.

A facility for manufacturing electrodes (an “electrode manufacturing facility”) 10 may include a roll assembly 100. The roll assembly 100 may transport the electrode sheet 20. For example, the roll assembly 100 may include at least one transport roll 120.

For example, the roll assembly 100 may include a plurality of transport rolls 120. For example, the roll assembly 100 may include a first transport roll 120a and a second transport roll 120b. The transport roll 120 may include or refer to at least one of the first transport roll 120a and the second transport roll 120b.

The transport roll 120 may be in contact with the electrode sheet 20. The transport roll 120 may rotate. The rotation direction of the transport roll 120 may correspond to the conveying direction of a portion of the electrode sheet 20 that is in contact with the transport roll 120.

The roll assembly 100 may include at least one heating roll 110. The heating roll 110 may be in contact with the electrode sheet 20. The heating roll 110 may supply heat to the electrode sheet 20. For example, a temperature of an outer surface of the heating roll 110 may be higher than a temperature of the portion of the electrode sheet 20 that is in contact with the heating roll 110.

A plurality of heating rolls 110 may be provided in multiple positions. For example, the roll assembly 100 may include a first heating roll 110a and a second heating roll 110b. The heating roll 110 may include or refer to at least one of the first heating roll 110a and the second heating roll 110b.

The rolls 110 and 120 may include or refer to at least one of the heating roll 110 and at least one transport roll 120. Among the plurality of rolls 110 and 120, two rolls 110 and 120 connected through the electrode sheet 20 may apply tension in a region of the electrode sheet 20 positioned between the two rolls 110 and 120.

The electrode manufacturing facility 10 may include a slot die 530. The slot die 530 may be disposed to face the heating roll 110. For example, the slot die 530 may be disposed to face the first heating roll 110a. A region of the electrode sheet 20 that comes into contact with the first heating roll 110a may be positioned between the slot die 530 and the first heating roll 110a.

A change in a “target region,” which is a portion of the electrode sheet 20, may be observed during transport. The target region of the electrode sheet 20 may be transported toward the first heating roll 110a. The target region of the electrode sheet 20 transported toward the first heating roll 110a may include the electrode foil 21 but exclude the coating layer 22.

The target region of the electrode sheet 20 that is transported toward the first heating roll 110a may come into contact with the first heating roll 110a. For example, the second electrode surface 20b of the target region of the electrode sheet 20 may come into contact the first heating roll 110a.

The target region of the electrode sheet 20 may be in contact with the first heating roll 110a while facing the slot die 530. For example, the first electrode surface 20a of the target region of the electrode sheet 20 may be disposed to face the slot die 530.

The slurry may serve as a material for forming the coating layer 22. The slot die 530 may apply the slurry to the target region of the electrode sheet 20. For example, the slot die 530 may apply the slurry to the first electrode surface 20a of the target region of the electrode sheet 20. The slurry applied to the electrode sheet 20 may form the coating layer 22 upon drying.

The target region of the electrode sheet 20 may be heated by the first heating roll 110a. For example, the temperature of the outer surface of the first heating roll 110a may be higher than the temperature of the target region of the electrode sheet 20.

The coating layer 22 of the target region of the electrode sheet 20 may receive heat from the electrode foil 21 of the target region of the electrode sheet 20. For example, a temperature of the coating layer 22 of the target region of the electrode sheet 20 may be lower than a temperature of the electrode foil 21 of the target region of the electrode sheet 20.

Before the target region of the electrode sheet 20 is dried by the electrode drying unit 300, the coating layer 22 in the target region of the electrode sheet 20 may be heated by the electrode foil 21 thus to be dried.

The target region of the electrode sheet 20 may be transferred from the first heating roll 110a to the second heating roll 110b. The temperature of an outer surface of the second heating roll 110b may be higher than the temperature of the target region of the electrode sheet 20. For example, the temperature of the outer surface of the second heating roll 110b may be higher than the temperature of the outer surface of the first heating roll 110a. For example, the second heating roll 110b may supply heat to the target region of the electrode sheet 20.

The electrode manufacturing facility 10 may include an electrode drying unit 300. The electrode drying unit 300 may include a drying housing 310. The drying housing 310 may define an internal space.

The transport roll 120 may be positioned inside the drying housing 310. For example, the first transport roll 120a and the second transport roll 120b may be positioned inside the drying housing 310.

The target region of the electrode sheet 20 may be transported from the second heating roll 110b to the first transport roll 120a. For example, during the transportation of the target region of the electrode sheet 20 from the second heating roll 110b to the first transport roll 120a, the target region of the electrode sheet 20 may enter the interior of the drying housing 310.

The electrode manufacturing facility 10 may include a sensor unit 400. The sensor unit 400 may include a temperature sensor 410. A plurality of temperature sensors 410 may be provided in multiple positions. For example, the sensor unit 400 may include a first temperature sensor 411 and a second temperature sensor 412. The temperature sensor 410 may include or refer to at least one of the first temperature sensor 411 and the second temperature sensor 412.

The temperature sensor 410 may be configured to measure the temperature of the electrode sheet 20. For example, the temperature sensor 410 may measure the temperature of the electrode sheet 20 using a non-contact method.

For example, the temperature sensor 410 may measure the temperature of the target region of the electrode sheet 20 that has entered the interior of the drying housing 310. For example, the temperature sensor 410 may measure the temperature of a region of the electrode sheet 20 positioned between the second heating roll 110b and the first transport roll 120a.

For example, the first temperature sensor 411 may be positioned inside the drying housing 310. For example, the first temperature sensor 411 may be disposed to face the first electrode surface 20a of the target region of the electrode sheet 20.

For example, the first temperature sensor 411 may measure a temperature of the first electrode surface 20a of the target region of the electrode sheet 20. For example, the first temperature sensor 411 may measure the temperature of the coating layer 22 of the target region of the electrode sheet 20.

For example, the second temperature sensor 412 may be positioned inside the drying housing 310. For example, the second temperature sensor 412 may be disposed to face the second electrode surface 20b of the target region of the electrode sheet 20.

For example, the second temperature sensor 412 may measure the temperature of the second electrode surface 20b of the target region of the electrode sheet 20. For example, the second temperature sensor 412 may measure the temperature of the electrode foil 21 of the target region of the electrode sheet 20.

The sensor unit 400 may include a vision sensor 420. The vision sensor 420 may be positioned between the second heating roll 110b and the first transport roll 120a. The vision sensor 420 may be positioned inside the drying housing 310.

For example, the vision sensor 420 may be disposed to face the first electrode surface 20a of the electrode sheet 20. For example, the vision sensor 420 may be disposed to face the coating layer 22 of the electrode sheet 20.

The vision sensor 420 may capture an image of the target region of the electrode sheet 20. For example, the vision sensor 420 may obtain an image of the coating layer 22 in the target region of the electrode sheet 20. The captured image of the coating layer 22 may vary depending on at least one of a drying state and the temperature of the coating layer 22.

The electrode drying unit 300 may include a heater 320. The heater 320 may be positioned inside the drying housing 310. After entering the interior of the drying housing 310, the target region of the electrode sheet 20 may receive heat from the heater 320.

The sensor unit 400 may obtain at least one of temperature information and an image of the target region of the electrode sheet 20 before the target region of the electrode sheet 20 receives heat from the heater 320.

A plurality of heater 320 may be provided in multiple positions. For example, the electrode drying unit 300 may include a first heater 321 and a second heater 322. The heater 320 may include or refer to at least one of the first heater 321 and the second heater 322. For example, the heater 320 may be positioned between the first transport roll 120a and the second transport roll 120b.

The heater 320 may supply heat to the electrode sheet 20, for example, in the form of radiation. For example, the first heater 321 may supply heat to the first electrode surface 20a of the target region of the electrode sheet 20. Likewise, the second heater 322 may supply heat to the second electrode surface 20b of the target region of the electrode sheet 20.

For another example, the heater 320 may supply a gas having a temperature higher than the temperature of the target region of the electrode sheet 20 (hereinafter referred to as “high-temperature gas”) to the target region of the electrode sheet 20. The gas may include air.

For example, the first heater 321 may supply the high-temperature gas to the first electrode surface 20a of the target region of the electrode sheet 20. Likewise, the second heater 322 may supply the high-temperature gas to the second electrode surface 20b of the target region of the electrode sheet 20.

The electrode foil 21 of the electrode sheet 20 may be heated by the heating roll 110. For example, the temperature of the electrode foil 21 of the electrode sheet 20 may increase by the heating roll 110.

The temperature of the electrode foil 21 may be higher than the temperature of the coating layer 22 by the heating roll 110. Therefore, the coating layer 22 may be heated and dried by the electrode foil 21. This process may be referred to as a “pre-heating process” or a “pre-drying process.”

The electrode sheet 20 may be heated or dried by the electrode drying unit 300. This process may be referred to as a “main heating process” or a “main drying process.”

The binder included in the coating layer 22 may migrate toward the first electrode surface 20a during the drying process. This phenomenon may be referred to as a binder migration phenomenon. The more pronounced the binder migration phenomenon, the weaker the bonding force between the coating layer 22 and the electrode foil 21 may become.

The heating roll 110 may suppress a rapid increase in the temperature of the coating layer 22. Accordingly, the pre-heating process or the pre-drying process may mitigate the migration phenomenon of the coating layer 22.

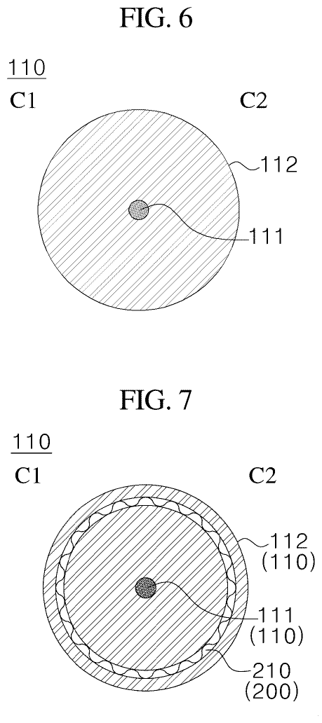

FIG. 4 is a perspective view of the heating roll shown in FIG. 1. FIG. 5 is a plan view of the heating roll shown in FIG. 4. FIG. 6 is a cross-sectional view illustrating the heating roll shown in FIG. 5, taken on line C-C.

Referring to FIGS. 4 to 6, the heating roll 110 may include a heating roll shaft 111. The heating roll shaft 111 may have an elongated shape extending in a longitudinal direction. The longitudinal direction of the heating roll shaft 111 may correspond to the longitudinal direction of the heating roll 110.

The heating roll 110 may include a heating roll contact surface 112. The heating roll contact surface 112 may form a portion of the outer surface of the heating roll 110. The heating roll contact surface 112 may have an elongated shape extending in the longitudinal direction of the heating roll shaft 111. For example, the heating roll contact surface 112 may have a pipe-like shape.

The heating roll 110 may rotate about the heating roll shaft 111. In other words, the heating roll shaft 111 may serve as a rotational shaft of the heating roll 110. For example, the heating roll contact surface 112 may rotate about the heating roll shaft 111 as its rotational shaft. For example, the heating roll contact surface 112 may be rotatably coupled or connected to the heating roll shaft 111.

The heating roll contact surface 112 may be in contact with the electrode sheet 20 (see FIGS. 1 to 3). For example, the heating roll contact surface 112 may be in contact with the second electrode surface 20b (see FIGS. 2 and 3). For example, the heating roll contact surface 112 may be in contact with the electrode foil 21 (see FIGS. 2 and 3).

FIG. 7 is a view illustrating a state in which a conduction heating module is coupled to the heating roll shown in FIG. 6.

Referring to FIG. 7, the electrode manufacturing facility 10 (see FIG. 1) may include a roll heating unit 200. The roll heating unit 200 may include a conduction heating module 210.

The conduction heating module 210 may be coupled to the heating roll 110. For example, the conduction heating module 210 may be positioned inside the heating roll contact surface 112. For example, the conduction heating module 210 may be positioned between the heating roll contact surface 112 and the heating roll shaft 111.

A metal material may be filled between the conduction heating module 210 and the heating roll contact surface 112. The conduction heating module 210 may deliver heat to the heating roll contact surface 112 through thermal conduction.

The conduction heating module 210 may include, for example, a heating wire. For example, when an electric current is applied to the conduction heating module 210, the temperature of the conduction heating module 210 may increase. For example, the electric current applied to the conduction heating module 210 may generate heat in the conduction heating module 210 through ohmic heating.

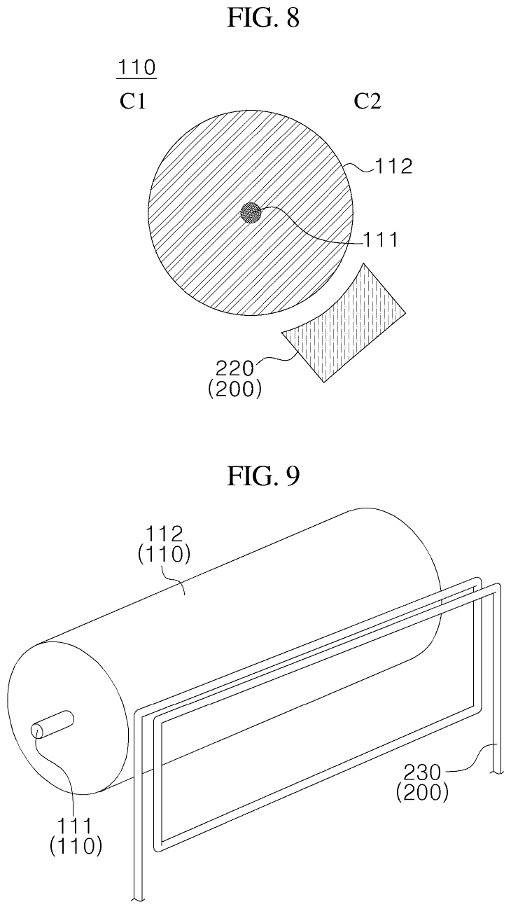

FIG. 8 is a view illustrating a state in which a radiation heating module is positioned adjacent to the heating roll shown in FIG. 6.

Referring to FIG. 8, the roll heating unit 200 may include a radiation heating module 220. The radiation heating module 220 may be positioned outside the heating roll 110. The radiation heating module 220 may be disposed to face the heating roll contact surface 112.

The radiation heating module 220 may supply heat to the heating roll contact surface 112. For example, the radiation heating module 220 may deliver heat to the heating roll contact surface 112 through thermal radiation. For example, the radiation heating module 220 may emit infrared rays onto the heating roll contact surface 112.

FIG. 9 is a view illustrating a state in which an induction heating module is positioned adjacent to the heating roll shown in FIG. 4

Referring to FIG. 9, the roll heating unit 200 may include an induction heating module 230. The induction heating module 230 may include a coil. For example, the induction heating module 230 may a wound shape.

The induction heating module 230 may be positioned outside the heating roll 110. For another example, the induction heating module 230 may be coupled to the heating roll 110. For example, the induction heating module 230 may be embedded within the heating roll 110.

For example, the induction heating module 230 may generate a magnetic flux. For example, the induction heating module 230 may generate a time-varying magnetic flux. For example, an alternating current may be applied to the induction heating module 230.

The time-varying magnetic flux generated by the induction heating module 230 may be applied to the heating roll 110. The heating roll 110 may generate heat in response to the time-varying magnetic flux.

For example, the heating roll 110 may induce an eddy current in response to the time-varying magnetic flux. The eddy current formed in the heating roll 110 may heat the heating roll 110 through ohmic heating. For example, the heating roll 110 may be heated by hysteresis loss caused by the time-varying magnetic flux.

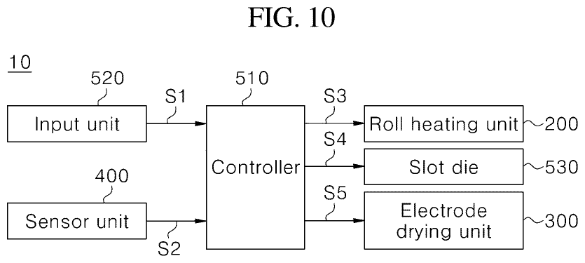

FIG. 10 is a block diagram illustrating the facility for manufacturing electrodes.

Referring to FIGS. 1 to 10, the electrode manufacturing facility 10 may include a controller 510. The controller 510 may be configured to perform calculations. The controller 510 may transmit and receive signals. The controller 510 may process the signals. The controller 510 may be implemented through at least one of a computer, a processor, a server or an electric circuit.

The electrode manufacturing facility 10 may include an input unit 520. The input unit 520 may be configured to receive an input from a user or the like. The input received by the input unit 520 may include information regarding an operation command of the electrode manufacturing facility 10.

The input unit 520 may generate a first signal S1 and transmit it to the controller 510. The first signal S1 may include information regarding the input received by the input unit 520.

The sensor unit 400 may transmit a second signal S2 to the controller 510. The second signal S2 may include at least one of the temperature information acquired by the temperature sensor 410 and the image information acquired by the vision sensor 420.

The controller 510 may generate output signals S3, S4 and S5 based on the input signals S1 and S2. The input signals S1 and S2 may include at least one of the first signal S1 and the second signal S2. The output signals S3, S4 and S5 may include at least one of a third signal S3, a fourth signal S4 and a fifth signal S5.

The controller 510 may transmit the third signal S3 to the roll heating unit 200. The third signal S3 may include information regarding an operation command of the roll heating unit 200. For example, the third signal S3 may include information regarding the power output of the roll heating unit 200. The roll heating unit 200 may be operated in accordance with the third signal S3.

The controller 510 may transmit the fourth signal S4 to the slot die 530. The fourth signal S4 may include information regarding the operation of the slot die 530. For example, the fourth signal S4 may include information regarding at least one of a distance between the slot die 530 and the first heating roll 110a and a slurry discharge rate per hour. The slot die 530 may be operated in accordance with the fourth signal S4.

The controller 510 may transmit the fifth signal S5 to the electrode drying unit 300. The fifth signal S5 may include information regarding the operation of the electrode drying unit 300.

For example, the fifth signal S5 may include information regarding the operation of the heater 320. For example, the heater 320 may be operated in accordance with the fifth signal S5. The fifth signal S5 may include, for example, information regarding at least one of a flow rate per hour and a temperature of the high-temperature gas.

The contents described above are merely examples of applying the principles of the present disclosure, and other configurations may be further included without departing from the scope of the present disclosure.

What is claimed is:

1. A facility for manufacturing electrodes comprising:
a heating roll which comprises a heating roll shaft extending in a longitudinal direction and a heating roll contact surface rotatably coupled to the heating roll shaft about the heating roll shaft;
a slot die disposed to face the heating roll while being spaced apart therefrom, and configured to dispense a slurry;
a roll heating unit configured to heat the heating roll contact surface; and
an electrode drying unit which comprises a drying housing and a heater positioned inside the drying housing.

2. The facility for manufacturing electrodes according to claim 1, wherein the roll heating unit comprises a conduction heating module housed in the heating roll contact surface and configured to supply heat to the heating roll contact surface.

3. The facility for manufacturing electrodes according to claim 2, wherein the conduction heating module is configured to generate heat through ohmic heating when a current is applied, and to heat the heating roll contact surface through thermal conduction.

4. The facility for manufacturing electrodes according to claim 1, wherein the roll heating unit comprises a radiation heating module disposed to face the heating roll contact surface and configured to emit infrared rays.

5. The facility for manufacturing electrodes according to claim 1, wherein the roll heating unit comprises an induction heating module including a coil having a wound shape.

6. The facility for manufacturing electrodes according to claim 5, wherein the induction heating module is configured to generate and supply a time-varying magnetic flux to the heating roll when an alternating current is applied.

7. The facility for manufacturing electrodes according to claim 6, wherein the heating roll is heated upon application of the time-varying magnetic flux.

8. The facility for manufacturing electrodes according to claim 1, wherein the electrode sheet comprising the electrode foil is in contact with the heating roll and rotates in conjunction with the rotation of the heating roll.

9. The facility for manufacturing electrodes according to claim 8, wherein the slot die is disposed to face the electrode foil and is configured to apply the slurry to the electrode foil.

10. The facility for manufacturing electrodes according to claim 9, wherein the slurry is applied to the electrode foil to form a coating layer, and
the coating layer comprises at least one of an active material, a conductive agent and a binder.

11. The facility for manufacturing electrodes according to claim 10, wherein a temperature of a portion of the electrode foil which is in contact with the heating roll is lower than the temperature of the heating roll contact surface and higher than the temperature of the slurry.

12. The facility for manufacturing electrodes according to claim 10, comprising:
a first heating roll which is disposed to face the slot die and serves as the heating roll; and
a second heating roll which is spaced from the first heating roll and serves as the heating roll,
wherein a target region, which is a portion of the electrode sheet, is transported after coming into contact with the first heating roll, and then comes into contact with the second heating roll.

13. The facility for manufacturing electrodes according to claim 12, wherein a temperature of the heating roll contact surface of the second heating roll is higher than the temperature of the heating roll contact surface of the first heating roll.

14. The facility for manufacturing electrodes according to claim 12, wherein the second heating roll is in contact with the electrode foil.

15. The facility for manufacturing electrodes according to claim 10, further comprising a first transport roll and a second transport roll, which are positioned inside the drying housing and in contact with the electrode sheet,
wherein the target region, which is a portion of the electrode sheet, is transported after coming into contact with the heating roll, and sequentially comes into contact with the first transport roll and the second transport roll.

16. The facility for manufacturing electrodes according to claim 15, wherein the heater is configured to heat a region of the electrode sheet positioned between the first transport roll and the second transport roll.

17. The facility for manufacturing electrodes according to claim 16, further comprising a temperature sensor configured to measure a temperature of a target region of the electrode sheet positioned between the heating roll and the first transport roll.

18. The facility for manufacturing electrodes according to claim 17, wherein the temperature sensor comprises:
a first temperature sensor disposed to face the coating layer and configured to measure the temperature of the coating layer; and
a second temperature sensor disposed to face the electrode foil and configured to measure the temperature of the electrode foil.

19. The facility for manufacturing electrodes according to claim 17, further comprising a vision sensor disposed to face the coating layer of the target region and configured to capture an image of the coating layer.

20. The facility for manufacturing electrodes according to claim 19, further comprising a controller configured to receive signals from the temperature sensor and the vision sensor,
wherein the controller controls at least one of the heating roll and the heater based on at least one of the temperature and the image of the target region.
